(19) United States
(12) Patent Application Publication
(10) Pub. No.: US 2014/0129454 A1
(43) Pub. Date: May 8, 2014

(54) Professional Services Portal

(71) Applicants: Samuel Alemu, Elgin, IL (US); Praveen Madikundam, Elgin, IL (US)

(72) Inventors: Samuel Alemu, Elgin, IL (US); Praveen Madikundam, Elgin, IL (US)

(21) Appl. No.: 13/668,235

(22) Filed: Nov. 3, 2012

(51) Int. Cl. G06Q 50/18

(52) U.S. Cl. CPC G06Q 50/18
USPC 705/311

(57) ABSTRACT

A system of hardware and software components and methods of providing a service portal such as a legal service portal are disclosed. For clients, the system offers several advantages including allowing clients to select professionals from a pre-qualified list of professionals, to provide their personal data only once to the system, to have their cases transferred from one professional to another electronically, and the ease of quick response to inquiries and electronic billing. For the legal professionals, the advantages include customized profile pages, membership in an exclusive network of pre-qualified professionals, referral of work, the ability to automate many mundane tasks for filling out various forms with similar customer data, and the ability to safely transfer or receive cases with complete electronic records, and the ability to collaborate with other professionals on a given case.

### FIELD OF THE INVENTION

The present invention relates generally to networked computer systems and methods for providing professional services and particularly to facilitating cooperation among professionals in providing professional services.

### BACKGROUND OF THE INVENTION

Websites that allow clients to initiate communication with a professional service firm such as a legal firm are known. Many of today's modern legal firms have their own dedicated websites geared towards listing the services that they provide. Such websites typically include a number of interconnected individual web-pages that provide information on the credentials of a firm's lawyers, their practice areas, important court cases they have won, the firm's community involvement, favorable ratings in reputable legal publications or surveys, contact information and the like.

In addition, websites that provide lists of attorneys specializing in various categories of practice such as personal injury law, real estate law, family law and the like are also known. Such websites are essentially online directories of legal services available in a particular area. The listings can be categorized based on the location of the lawyers or the legal firms, or practice areas or both.

There are various shortcomings associated with such web based online services. A potential client has little way of ascertaining the information provided, or assessing whether a particular lawyer is suited for his or her purposes. In addition, the client's particular case may require more than one lawyer, or may involve multiple jurisdictions.

Accordingly, improvements to existing methods and systems of providing online professional services are desired. It is therefore an object of the following to provide novel methods and systems of providing professional services using various communication technologies that overcome the disadvantages associated with existing systems.

### SUMMARY OF THE INVENTION

Embodiments of the present description disclose systems of hardware and software components that provide professional service portals. The system offers several advantages to clients including quotes for services, a pre-qualified list of professionals, ability to reuse their personal data for multiple actions, ability to remotely obtain services in a particular non-local jurisdiction, to transfer their cases from one professional to another electronically, and the ease of quick response to inquiries and electronic billing. For the professionals, the system offers many advantages including, listing their services with customized profile pages, membership in an exclusive network of pre-qualified professionals, referral of work from the system, ability to automate many mundane tasks for filling out various forms with similar or identical customer data, the ability to safely transfer (or receive) cases to other professionals with complete electronic records, and the ability to cooperate on a particular case with other professionals, among other advantages.

In accordance with one aspect of the present invention, there is provided a method of providing a service to a client on a case, using a computer system having data related to the case stored in memory. The system has an account for each of a first professional and a second professional. The data is accessible to the first professional's account but inaccessible the second professional's account. The method includes: logging in to the first professional's account; sending a request message to the second professional's account requesting the second professional to work on the case; receiving an acceptance message from the second professional's account indicating acceptance; and upon receiving the acceptance message, making the data accessible to the second professional's account thereby allowing the second professional to work on the case.

In accordance with another aspect of the present invention, there is provided a server having a processor; memory; and a network interface for interconnecting to a computing device through a network. The network interface and memory are coupled to the processor. The memory stores software in the form of processor executable instructions adapting the processor to: maintain an account for each of a client, a first professional and a second professional; receive user input from the device by a user logged into the client's or the first professional's account; in response to the user input: store data related to a case associated with the client in the memory such that the data accessible to the first professional's account but not the second professional's account; and send a request message to the second professional's account requesting the second professional to work on the case; receive an acceptance message from the second professional's account indicating acceptance; and upon receipt of the acceptance message, make the data accessible to the second professional's account thereby allowing the second professional to work on the case.

In accordance with yet another aspect of the present invention there is provided a computing device for providing a service to a client on a case, comprising: a processor; an input device; memory storing processor executable instructions; and a network interface for interconnection to a server having an account for each of the client, a first professional and a second professional, the server storing data related to the case, the input device, network interface and memory connected to the processor, the instructions adapting the processor to: receive login input through the input device to log into the first professional's account on the server; send a request message to the second professional's account requesting the second professional to work on the case; upon receipt of an acceptance message from the second professional's account indicating acceptance, transmit commands to the server making the data accessible to the second professional's account thereby allowing the second professional to work on the case.

### BRIEF DESCRIPTION OF THE DRAWINGS

Embodiments will now be described more fully with reference to the accompanying drawings in which:

FIG. 1A depicts a simplified block diagram of a networked computerized system exemplary of an embodiment of the present invention;

FIG. 1B depicts a simplified block diagram of a computing device used in the system of FIG. 1A;

FIG. 2 depicts a simplified data model of entities stored in tables within the database server software depicted in FIG. 1A;

FIG. 3 is a flowchart depicting the sequence of steps that are undertaken to create an account for a professional in the system of FIG. 1A;

FIG. 4A is an exemplary webpage that may be used to apply for a client account in the system of FIG. 1;

FIG. 4B is an exemplary webpage that may be used by a client to describe a matter in order to solicit professional advise, using the system of FIG. 1;

FIG. 5 is a flowchart that summarizes the steps taken by a professional to accept a client and provide a service using the system of FIG. 1A;

FIG. 6 depicts a flow chart that summarizes the actions taken by a client that would correspond to the steps of the attorney as depicted in FIG. 5;

FIG. 7 depicts a flowchart that summarizes the actions of a first professional handling a case for a client, that transfers the case to a new professional;

FIG. 8 depicts a flowchart of the actions taken by a client in a first country, to create a legal case in a second country;

FIG. 9 depicts a flowchart of the actions taken by an attorney in the first country, to create a legal case in a second country for the client of FIG. 8;

FIG. 10 depicts a flowchart summarizing the actions of a second attorney in the second country identified in the flowchart of FIG. 9; and

FIGS. 11A-11B depict flowcharts summarizing the actions of a first and a second professional collaborating on a case.

### DETAILED DESCRIPTION OF THE EMBODIMENTS

The present invention is directed to a system that allows multiple clients and multiple professionals to interact electronically in a convenient and secure manner. The system thus facilitates secure and trustworthy electronic commerce in the provision of professional services. Some embodiments are described in relation to the particular field of providing legal services. As will be described in later, the system provides clients with a networked environment that allows them to conveniently compare service offerings in an environment that provides many advantages including safeguarding against unqualified solicitors, pricing transparency, receiving collaborative service by two or more professionals, convenient transfer of cases from one attorney to another, avoidance of duplicate data entry, accuracy and many other advantages. Legal professionals are similarly assured of serious prospects, potential for work that is referred by other qualified professionals, collaboration with various other specialists in the legal field, secure collaboration with one or more attorneys working on a single case, transferring cases or receiving cases to and from other professionals, and accurate and centralized record keeping that reduces redundant, error prone data entry activities among other advantages.

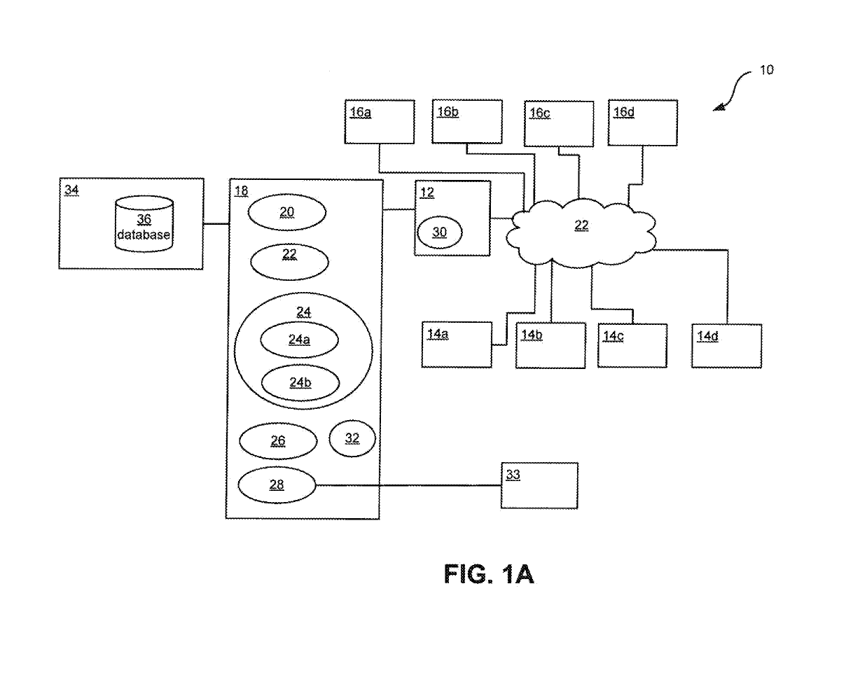

FIG. 1A depicts a simplified block diagram of a networked computerized system 10 exemplary of an embodiment of the present invention. As depicted, the system 10 has a server computer system that includes a web server 12, a business logic server 18, a database server 34; and also computing devices 14a to 14d used by clients and computing devices 16a to 16d used by professionals.

Each of the servers 12, 18, 34 and computing devices 14a to 14d and devices 16a to 16d may be a laptop or desktop personal computer, a tablet computer, a smart-phone, a server computer, or any other suitable computing device. An exemplary computing device hardware is depicted in FIG. 1B.

As shown in FIG. 1B, an exemplary computing device hardware includes a processor 70, memory 72 and a network interface 77 interconnected by an interface circuit 74. The interface circuit 74 is also used for interconnection with input and output components such as a display 76 which may be a touch screen, and optionally one or more peripherals 78 such as keyboards, electronic mice and the like. The processor 70, memory 72 and network interface 77 are in electrical communication with one another. The memory 72 may be in the form of volatile and/or non-volatile memory, including for example, a hard disk drive, random access memory (RAM), read-only memory (ROM), EEPROM, CD-ROM, DVD, flash memory, solid state memory and the like. The interface circuit 74 may include system bus coupling the various computer components or peripherals 78 such as display monitors, keyboards, touch panels, joysticks, mouse or other pointing devices, networking interfaces and the like to the processor 70. Many types of interface circuits are known including ISA (Industry Standard Architecture), MCA (Micro Channel Architecture), EISA (Extended Industry Standard Architecture), VLB (VESA Local Bus), PCI (Peripheral Component Interconnect), PCI-X (Peripheral Component Interconnect Extended), AGP (Accelerated Graphics Port), PCI Express (Peripheral Component Interconnect Express or PCI-e) and the like. The network interface 77 may be a wired or wireless network interface card that allows communication with other computers through a data network such as network 22.

Software applications, in the form of processor executable instructions stored in memory forming part of, or at least accessible to, each of web server 12, business logic server 18, database server 34, client computing devices 14a to 14d and computing devices 16a to 16d are executed by their respective processors to implement various embodiments of the present invention, as will be detailed later. The software applications, in the form of processor executable instructions, may also be stored in a processor readable medium such as a CD, DVD, USB memory stick, hard-disk or the like, to be loaded onto a computer system to implement the system 10.

The network interface 77 of these computing devices may include network interface cards that facilitate wired or wireless connections, such as Ethernet, Wi-Fi, Bluetooth, and/or other suitable network formats, to enable connection to shared or remote drives, one or more networked computers, or other networked devices, input peripherals and the like. A mouse and a keyboard, or alternately a touch surface may be used to provide input using the computing devices. Such input devices may be built-in parts of the computing device, or external peripherals. Many network capable devices capable of running client software applications such as web-browsers are ubiquitous and will be well known to persons skilled in the art.

In the embodiment depicted in FIG. 1A, the server computer 12 includes at least a web-server software 30 such as the Apache server or the Internet Information Server (IIS) that allows browser client software (e.g., Internet Explorer, Mozilla Firefox, Safari etc.) running on computing devices 14a to 14d as well as devices 16a to 16d to access the system 10 through a network 22 such as the Internet or other wide area networks, campus area networks or the like. In some embodiments, the transmission of data between computing devices 14a to 14d or 16a to 16d and server computer 12 may be encrypted to secure the data. A portal running on server computer 12 utilizing a secure protocol such as the widely used Hypertext Transfer Protocol Secure (HTTPS) can be accessed via a suitable browser and used for data entry, account creation, and various activities to be described later. In addition, database software 36 may be implemented as an encrypted database.

The business logic server 18 interconnects to the web server 12. The business logic server 18 includes a number of modules that execute business rules and enforce restrictions associated with different types of clients as well as administrative module. To that end, the business logic server 18 includes an attorney module 20, a client module 22, and a number of specialized vendor modules 24 such as a paralegal module 24a, a bonding service module 24b and the like, that are customized for specific types of users such as paralegals, bond service providers, draftspersons, translators and the like that may be involved in a particular legal case.

The business rules server 18 may also include a case management module 26 that allows cases to be created and managed by the responsible attorney. The server 18 also includes an administrative module 28 that may be used to create, maintain and manage user accounts and related administrative functions such as creating or deleting user accounts for users of the system, specifying account types, access levels and privileges for user accounts (e.g., client account, professional account, vendor account, or administrator level permission, read-only permission, read-write permission etc.), data backup and recovery related functions and the like. In addition a billing module 32 in server 18 may be used for billing related functions. In some embodiments, the billing module 32 includes payment identifiers associated with external accounts such as credit card accounts, bank deposit account numbers, PayPal account numbers and the like. However, in other embodiments, the payment identifiers can be prepaid accounts, credit line accounts and/or custom deposit accounts that are maintained within system 10.

The business rules server 18 interacts with the database server 34 that provides data repository or data store for persistent data. As is well known, persistent data is required for applications that reuse saved data across multiple sessions. The database server 34 of course includes at least one database software 36 which may be relational database management software (RDBMS) such as a MySQL server, Oracle server, Microsoft SQL Server database or alternatives. The database software 36 may also be implemented as object-oriented database server software in alternate embodiments, instead of an RDBMS as described herein.

In addition to computing devices 14a to 14d and computing devices 16a to 16d that access the business rule server 18 via the web-server software 30 through the network 22, dedicated administrative computing devices such as computing device 33 can also be used to directly access the business rule server 18. In some embodiments, computing device 33 and business rules server 18 may be connected in a local area network and may reside in the same physical location.

The system 10 may additionally interact with other servers including an email server as well as instant messaging server (not shown), and other servers to provide communication, archiving, backup and other auxiliary services including web services and other software as a service (SaaS) offerings from third parties. In addition one or more of the modules in business server 18 may be provided by third parties in other embodiments.

As will be appreciated by those skilled in the art, a data model such as entity-relationship (ER) diagrams or database table diagrams may be used to model the entities involved in the design of a particular database schema to handle the persistent data associated with the functions of the system 10.

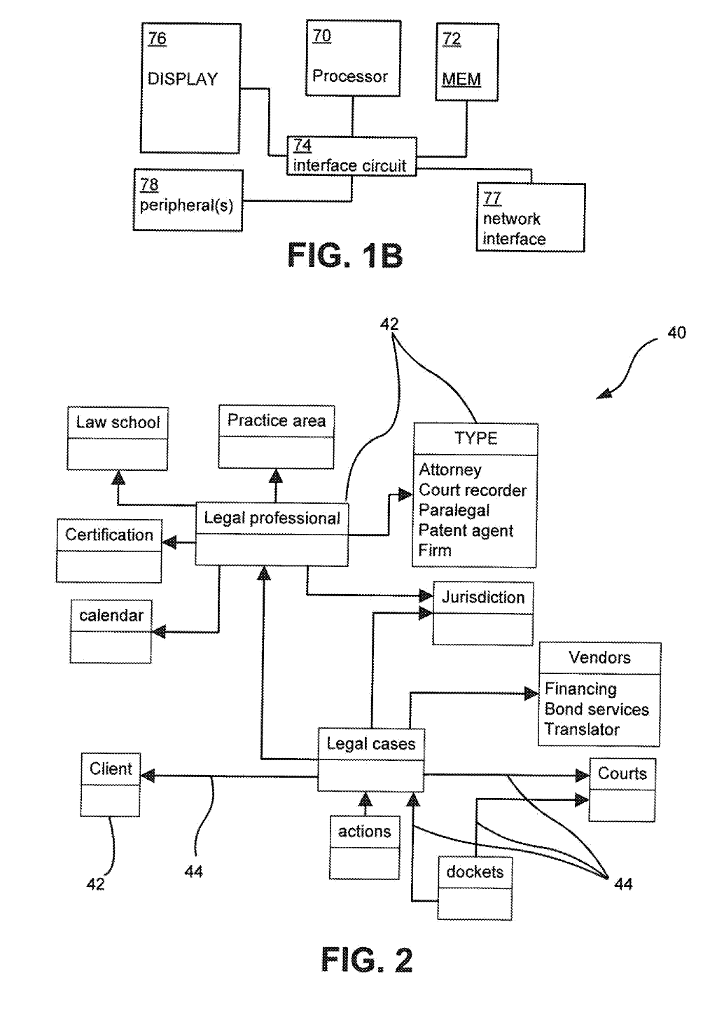

FIG. 2 depicts a simplified exemplary data model 40 of entities 42 stored in tables within the databases hosted in database software 36 and relationships 44 that indicate interrelationships between the entities 42. The entities 42 in data model 40 include legal professionals such as attorneys, paralegals, translators, court recorders, patent agencies, legal firms, and the like. The entities 42 in data model 40 also include clients, legal and/or geographic jurisdictions, legal qualifications or certifications, legal institutions such as law schools or patent offices or individual courts; legal cases, vendors and the like. The vendor entity includes service providers to clients such as bond service providers, financing firms and the like.

The relationships 44 may include attorney-case relationships, attorney-client relationships, jurisdiction-attorney relationships, case-court relationships and the like. A subset of these relationships 44 is represented by the set of arrow lines interconnecting the various representative entities depicted in FIG. 2.

Of course each entity includes many attributes, often implemented as columns within tables, which characterize the entity. For example a legal professional entity, such as an attorney may include many attributes including attorney name, attorney address and current hourly rate. In addition to attributes, relationships are used to indicate law schools attended, bar admissions, other certifications such as academic degrees, registration as patent agent, or other specialized training certifications and the like. It will be apparent to persons skilled in the art that there are various alternative ways of representing relationships including dedicated relationship tables, columns restricted to having foreign key entries and the like depending on whether the relationship is one-to-many, many-to-many, optional, or required.

In addition a legal professional may be related to single calendar entity that allows his or her availability to be made available for use by other modules in the system when creating associations, cases and the like.

Membership in system 10 is voluntary. However, embodiments of the system 10 impose qualification criteria on professionals who wish to join system 10. In one exemplary embodiment, when a prospective attorney wishes to join the system, the attorney provides information about his or her professional credentials such as legal training, bar admission, and areas of law in which he practices, among other data such as residency or citizenship, to the system 10. The prospective attorney may use a web-page or a sequence of web-pages to provide the data to the system. Alternately, a predefined electronic form may be filled out and sent to a dedicated email address which is received in system 10. The data provided may include, for example, the number of years in practice, year of bar admission, nature of the practice whether in-house, in a boutique legal firm, general services large firm, sole practice or the like.

After the prospective attorney's data including credentials data input is gathered, one or more people may be assigned to investigate the supplied credentials. Alternately the system may be internetworked with relevant external databases to automatically authenticate or verify the supplied prospect data. The prospective attorney's data may thus include some required data fields and other optional data fields.

The system 10 may perform a series of checks including whether all required data have been supplied by a prospective member. The data are further checked for ensure accuracy. As noted just above, these may involve manual and/or automated processes such as consulting public records, checking law school records, comparison with data in private or public databases, interviews and/or written correspondences with the prospective attorney as well as document submissions. Such checking may also be sent electronically to an external party specializing in reference checking for specialized fields.

After the accuracy of the prospective attorney's data is ascertained or verified, the system 10 via its administrative module 28 in server 18 may receive verification data and proceeds to create a professional attorney account, along with the corresponding entity in the corresponding table in database software 36 with the requisite access privileges in the system. Attributes such as address, bar admission, residency, jurisdiction and the like are also entered into and stored in corresponding columns in the appropriate related fields and associated with the newly created attorney entity.

The prospective attorney, having satisfied all criteria for membership, thus becomes a member attorney, and provided with an account created for him or her, and is notified of his or her user name and password to enter the system 10 via the account created. As the database software 36 is accessible through the servers 12, 18, 34 and network 22, by way of a web-browser in a device (e.g., device 16a) in the depicted embodiment, the attorney, just like any other system user, may access the portal by logging in after providing the supplied user name and password.

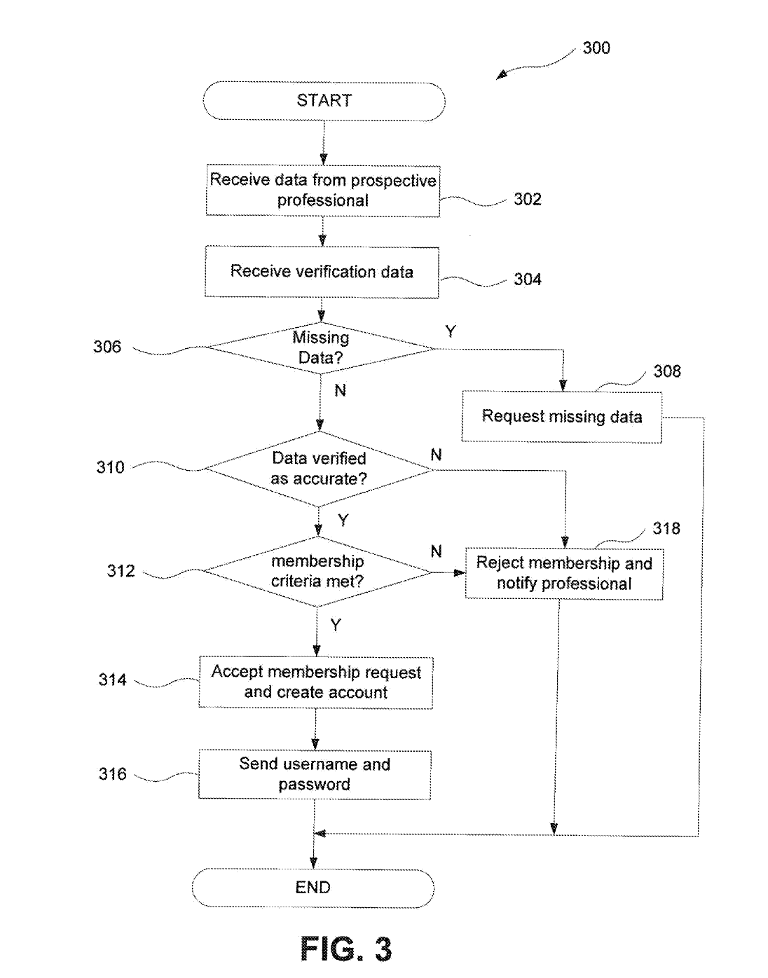

The sequence of events undertaken to create an account for a professional member such as an attorney is summarized by a flowchart 300 as depicted in FIG. 3. As shown, initially the system receives data associated with the application of a prospective attorney for membership (step 302). The data may include personal data, as well as data related to the professional credentials of the applicant.

The system 10 then receives verification data for the supplied data (step 304) either asserting or denying the accuracy of the data supplied in step 302. This step 304 can be an automated process where an external database can be accessed by the system to verify the data. Such external databases can be accessible via web-services for example, and may allow the system 10 or administrator module to verify if a prospective member is a member of particular bar association or a patent agent or a member in good standing of a particular professional society. In other embodiments, this step may be performed manually by traditional means instead of being handled automatically by system 10, and the verification results may be provided to the administration module 28 in a predetermined format.

As shown in flowchart 300, the module 28 then checks if any piece of data required to evaluate the prospect is missing (step 306). If any of the data is missing then the server 18, in this embodiment, sends a request for the missing data to the prospect such as by displaying a webpage, sending an email, sending a text message, sending a chat message, or updating a status in a web based application accessible through system 10.

If there are no missing pieces of data (step 306) then the server 18 checks if the supplied data is verified (step 310). If the verification step fails the admission request is rejected (step 316). However if the verification step is passed, the verified data is now compared to the membership admission criteria (step 312). If the admission criteria are satisfied (step 312), the server 18 creates accepts the membership request of the prospective professional (step 314) and creates a user name and password and provides it to the prospective member (step 316). If however, the criteria are not met, the server 18 rejects the application (step 318). The process is then terminated.

One exemplary criterion for admitting a legal professional is membership in at least one state bar association. Another criterion for prospective attorneys claiming to be patent attorneys may be registration as a patent agent before the United States Patents and Trademarks Office (USPTO) in addition to admission to at least one state bar association. Many alternatives are possible depending on how the prospective member wishes to be profiled, and can be flexibly setup in the business rules server 18.

In some embodiments, after a legal professional (e.g., attorney) is provided an account in the system 10, an electronic profile card or a personalized webpage is automatically created for the legal professional. For example, after an attorney is admitted into the system, an information card, or a personal profile card or a profile webpage is automatically created for the attorney indicating for example, year of graduation from law school, date of bar admission, and other qualification data supplied during registration. The profile card or webpage may also include hourly rates, practice areas of law, representative cases won and the like.

The information card for an attorney may be used a response template to inquiries from clients, and may include, in one embodiment: the amount charged for first consultation (or an indication that it is free), law school attended, experience (e.g., in years), availability (e.g., weekend hours, 24 hour service, etc.), and other commentary or remarks by the attorney to highlight some particulars.

Similarly, a court reporter or paralegal may also have automatic profile pages created that include experience, qualification and related information.

Prospective clients must also have accounts created in the system in order to utilize it to shop for services. Unlike legal professionals however, clients need not provide data related to professional credentials. In some embodiments, credit card information or other payment identifiers such as PayPal accounts or bank deposit accounts may be required for customers to become registered users.

Applying for a client user account may be accomplished in using a simple registration web-page on a portal running on server 12 and providing contact information and other personal data.

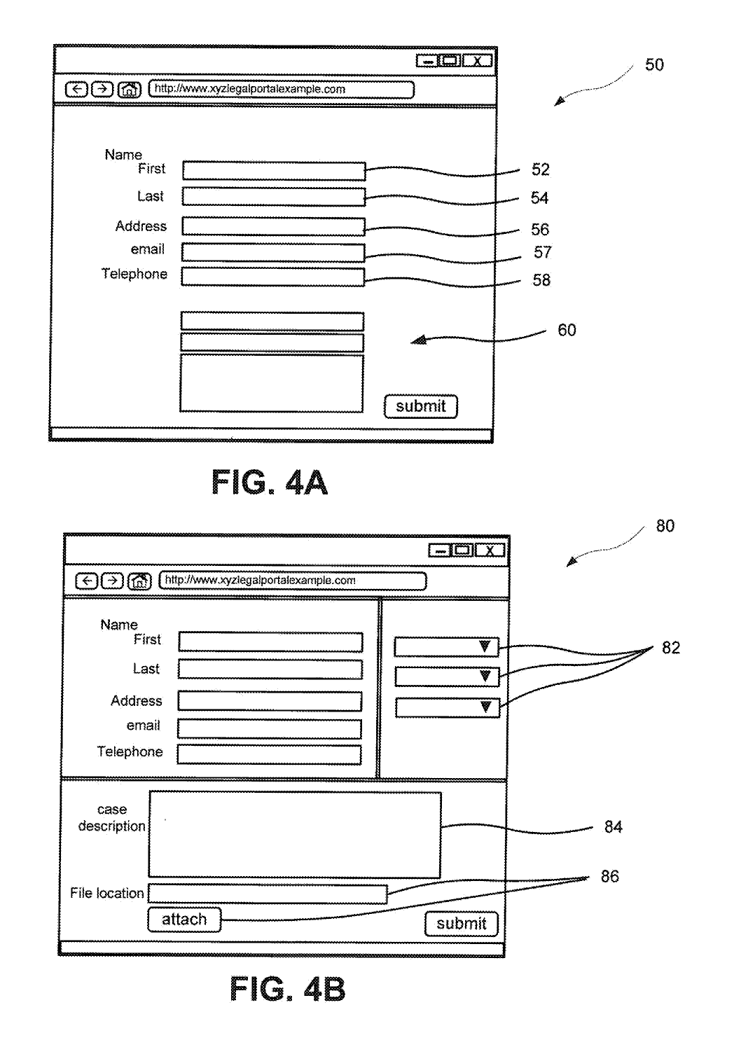

An exemplary webpage is depicted in FIG. 4A. A webpage 50 may have several input fields including first name field 52, last name field 54, mailing address field 56, email address field 57, telephone number 58, and the like. Additional data fields 60 may also be used to collect data such as such as nature of the service sought, residency, citizenship, marital status and the like may also be collected. In alternate embodiments, webpage 50 may also be used by prospective attorneys or other professionals. The additional fields 60 may be used to provide professional credentials and/or experience related information.

Upon the use clicking the submission button on webpage 50, the system collects and checks data in the data fields. Administration module 28 then creates an account for the user and provides the user with a username and password for future use, provided all relevant information is provided and checked to be satisfactory. This involves creating a new user entry with a unique user identifier in the appropriate table within database software 36. The newly created username and passwords may be emailed to the supplied email address, or sent via text to a supplied mobile phone number. Alternately, the email address may be designated as the username and only the password may be sent to the new user.

The email sent to the new user may be an HTML email having a link to a webpage embedded therein. The username and password can be viewed in a browser that opens the embedded link in the HTML email. Many variations are possible.

Once a client user account has been created then the client may login to the portal of system 10 and shop for services. In one embodiment, after logging into the system 10, the client may be presented with a web-page 80 as depicted in FIG. 4B. The client's information already collected during registration such as name, address, telephone and email can be automatically pre-populated to help save time and ensure accuracy. However, the client may now use the additional user interface controls 82 to select particular legal fields, particular jurisdictions and/or a range of hourly rates to obtain a list of member attorneys that fit the criteria.

Alternately, if no filtering is desired, the controls 82 may be left in their unselected states so that the information collected can be made available to all registered professionals. For legal advice, the client user may simply state the legal problem for which a legal service solution is sought in text field 84 along with, optionally, a corresponding budget, and thereafter submit the potential case into a shared area that is accessible to all lawyers in the system. Additionally, the client may also attach or upload documents relevant to the case using the user interface controls 86 as shown in FIG. 4B. Of course, an individual attorney may be able to opt out of receiving general solicitation, or may customize preference settings in his or her account that determine which types of client requests are made available to him or her.

In alternate embodiments, an attorney can help a particular client register for a user account in system 10, and also help the client describe the nature of the legal advice needed. Accordingly, the attorney may interview the client, and actually enter the required input data into the system using for example, web-page 80, on the client's behalf. For example, one of the devices 16a to 16d in FIG. 1A may be a portable computing device that an attorney may travel with. The portable computing device may be a tablet computer such as an iPAD™, Galaxy Tab™, Blackberry PlayBook™ or the like. The attorney can arrange an interview with the client either by telephone, or face to face at an agreed upon location. The attorney can then ask all of the requisite information from the client and enter the information into system 10 using his tablet computer.

As noted above, the collected information typically includes basic biographic data, a summary of the legal case to be created and relevant documentation. The documentation may be provided by the client in hardcopy form, and the attorney may scan the hardcopy document to create softcopies that can be uploaded into the system 10. Scanners that can create softcopies of hardcopy documents are well known in the art and are ubiquitous in office supply stores.

The attorney then proceeds to create a user account for the client, enters the collected data and softcopies of documents, and distributes the potential case to the target attorneys within the system 10 on the client's behalf.

Such face-to-face meetings or telephone interviews with clients are often necessary when the clients are not well versed with the user of computer systems, or otherwise lack the means or the knowhow to utilize the system 10 by themselves.

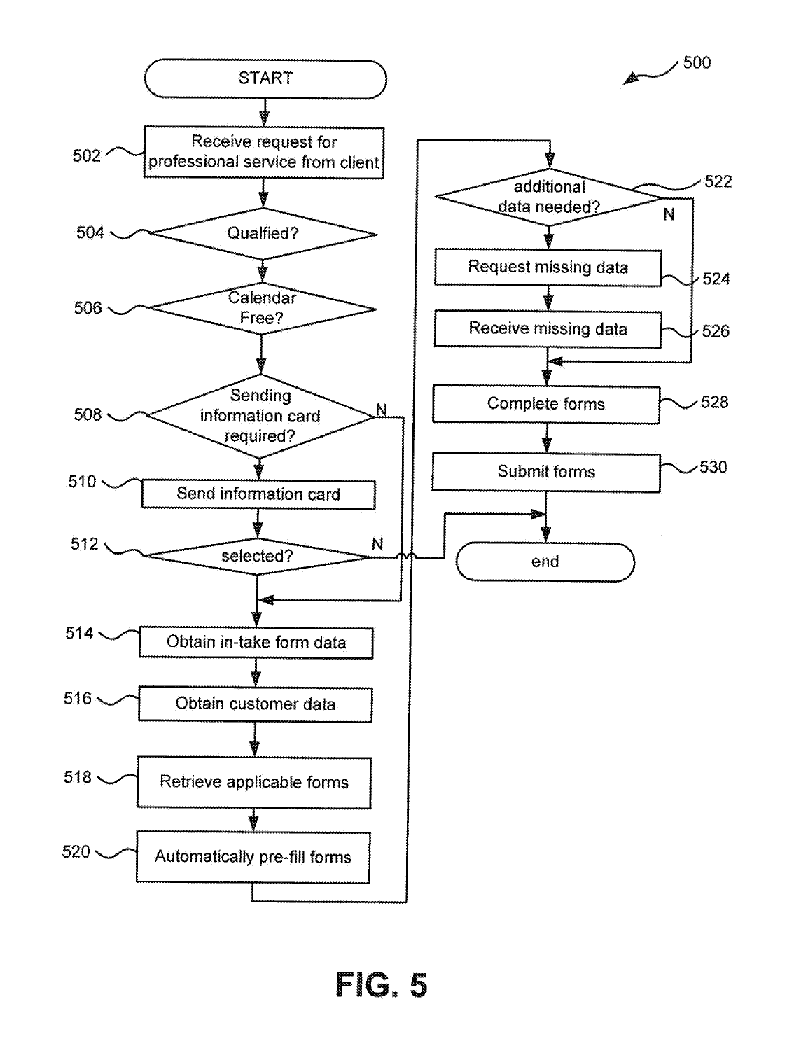

In the depicted embodiment above, two or more lawyers or attorneys may offer service packages to the client using system 10. FIG. 5 depicts one exemplary embodiment of a flowchart 500 that summarizes the steps taken by a legal professional to offer his services utilizing the system 10, and upon the client's acceptance of his offer, provide a legal service.

As depicted in flowchart 500, initially the professional (e.g., attorney) receives a request (step 502) for professional service from a client registered in system 10. If the attorney is qualified (step 504) to take on the case, then the professional's calendar is checked to see if it is free (step 506). If sending an information card is required (step 508) to undertake the case, an information card is submitted (step 510). If the attorney is selected to take the case (step 512) then the attorney obtains case related data (step 514) already submitted by the client. If sending an information card is not required (step 508) to undertake the case, then the attorney proceeds to step 514. That is, if the attorney has already been selected by the client and is the only legal professional receiving the request for the service, then there is no need to submit an information card and wait to be selected.

In addition, additional client data that has not been forwarded is retrieved by the attorney (step 516). The attorney then proceeds to retrieve applicable forms such as standard legal forms (step 518) as needed which are prefilled automatically by the system (step 520). If additional data is required (step 522) and is not readily available in the system 10 then the attorney requests (step 524) and obtains (step 526) missing data from the client.

In this particular embodiment the attorney requests (step 524) and obtains (step 526) the documents electronically, entirely within the system 10. In other embodiments, other means of communication and means of obtaining the documents may of course be used.

The attorney then completes the forms (step 528) and submits the required forms, briefs and supporting documents (step 530) on the client's behalf.

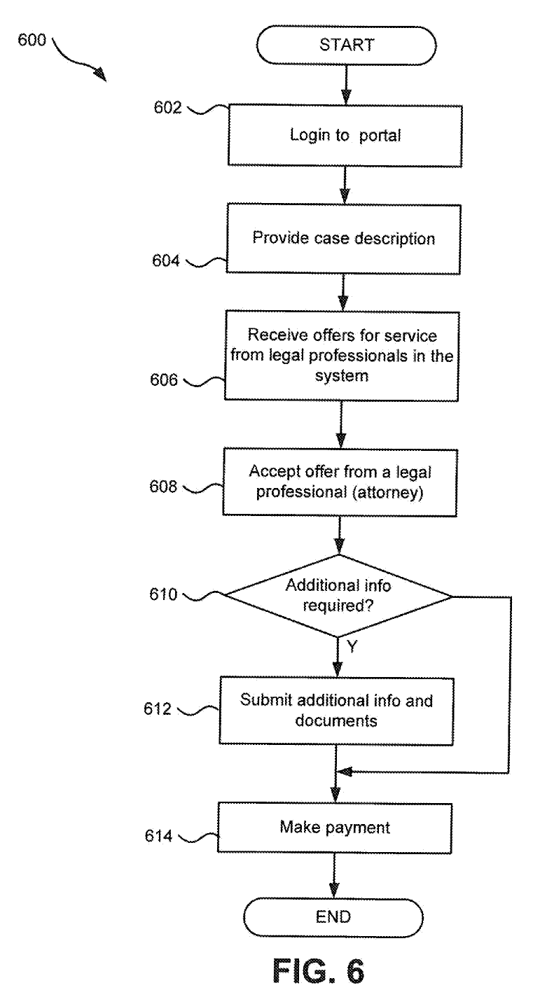

FIG. 6 depicts a flow chart 600 that summarizes the actions of the client that would correspond to the steps depicted in flowchart 500 describing the actions of the attorney.

As shown in FIG. 6, initially the client accesses the portal by logging in (step 602) and provides a description of the case (e.g., a legal case) that the client would like to be handled by a professional (e.g., attorney) in the system (step 604). The client then receives an offer or multiple offers for service (step 606) either from a selected professional, from multiple professionals where the system allows multiple professionals to offer services.

The client then accepts an offer (step 608) from a selected attorney. Of course if additional information and documents are needed (step 610) they may be requested by the selected attorney and will be provided (step 612) by the client as needed. The client will then effect payment (step 614) for the service rendered by the legal professional. In one specific embodiment, the payment can be provided using billing module 32 of the system 10 of FIG. 1.

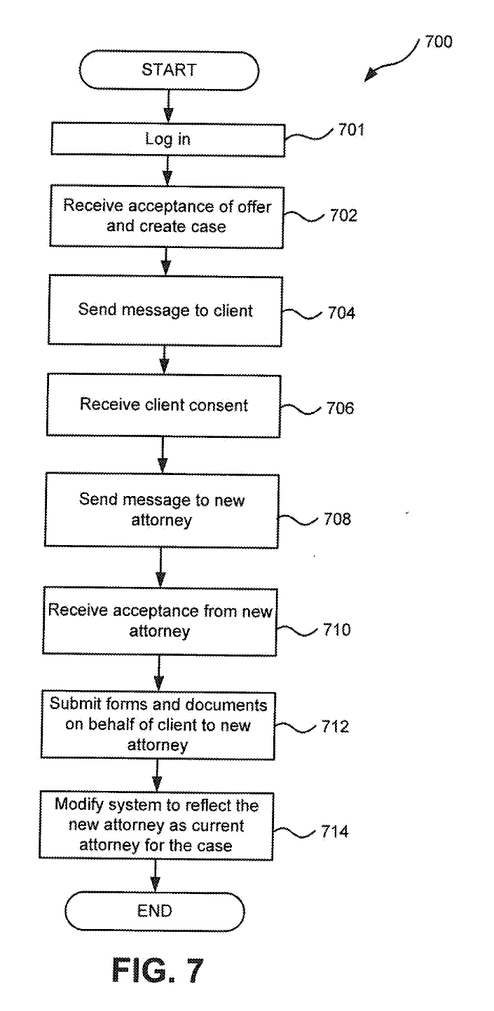

FIG. 7 depicts a flowchart 700 that summarizes the actions of a first professional (e.g., attorney) associated with a case for a client that transfers the case to a new second professional (e.g., attorney). This type of transfer of cases may occur in many scenarios such as complicated legal cases where the current or first attorney undertakes some early aspects or matters in the case but lacks the required specialization to peruse the case further, or if the first professional suddenly becomes unable to continue with the case, or by mutual agreement between the client and the first professional to have the case handled by a new professional.

As depicted in flowchart 700, initially the first professional logs into the portal of system 10 (step 701) and receives acceptance of his or her offer to handle the request from the client and creates a case (step 702) within system 10. The first professional, in this embodiment, then sends a message to the client to get the client's consent to transfer the case (step 704), and subsequently receives the consent (step 706). The first professional then sends a message to a new second professional to take over the case (step 708) and receives an indication of acceptance from the second professional (step 710). The first professional then makes the documents and data of the case accessible to the new professional (step 712). The first professional may then formally transfer the case by associating the new professional with the case (step 714) using server 18 of system 10. This completes the transfer of the case from the first professional to the second professional. At this point both professionals have access to data related to the case. In alternate embodiments, the case may have only one sole representative at a time, and upon transferring the case to the second professional, the first professional may no longer have access to the data associated with the case. Many variations of access privileges are possible. In other alternative embodiments, flowchart 700 may be executed by a client, by skipping steps 702, 704 and 706 which are unnecessary when a client is using the system. This allows the client to take charge of his or her representation and transfer the case from one professional to another.

As flowchart 700 is executed the server subsystem of system 10 made of servers 18, 12, 34 accommodates the process by maintaining an account for each of the client, the first professional or attorney and the second professional. The server subsystem receives user input from the device by a user logged into the first professional's account or the client's account and in response to the user input: store data related to the case in a memory of the server subsystem such that the data accessible to the first professional's account and the client's account but not the second professional's account; and send a request message to the second professional's account requesting the second professional to work on the case; receive an acceptance message from the second professional indicating acceptance; and upon receipt of the acceptance message, make the data accessible to the second professional's account thereby allowing the second professional to work on the case.

In a related but different embodiment, the system 10 can be used for multi-jurisdictional collaboration of attorneys to help a client. Consider a scenario in which a family from Kenya travels to New Zealand for a vacation using a tourism package purchased from a company specializing in tourism. Upon arrival in New Zealand the family finds that the promises of the company were not kept. For example, a five-star hotel was promised but only a three-star hotel was accommodation was provided. In addition, services that were included in the package were not honored and the family had to pay extra, out of pocket.

The family may initiate a legal case against the company in one of at least two ways. In one embodiment, the family may initiate the case by logging into the portal of system 10 and while still in New Zealand soliciting for the services of a lawyer in New Zealand. In that case, the flowchart 600 is largely applicable. The family thus accesses the portal for system 10 by logging in (step 602) in New Zealand and provides a description of the case that the family would like to be handled by a New Zealand attorney in the system (step 604). The family then receives an offer for services or multiple offers for service from multiple candidate attorneys (step 604). The family then accepts an offer (step 608) from a selected attorney in New Zealand and if additional information and documents are needed (step 610), they are requested by the New Zealand attorney and will be provided (step 612) by the family as needed. Payments may then be effected (step 614).

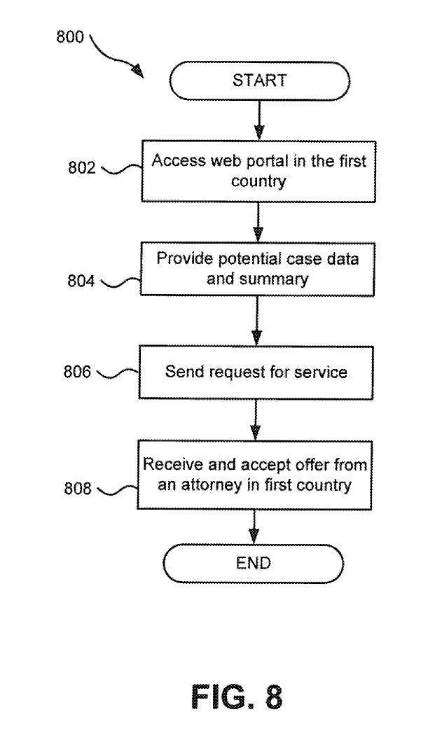

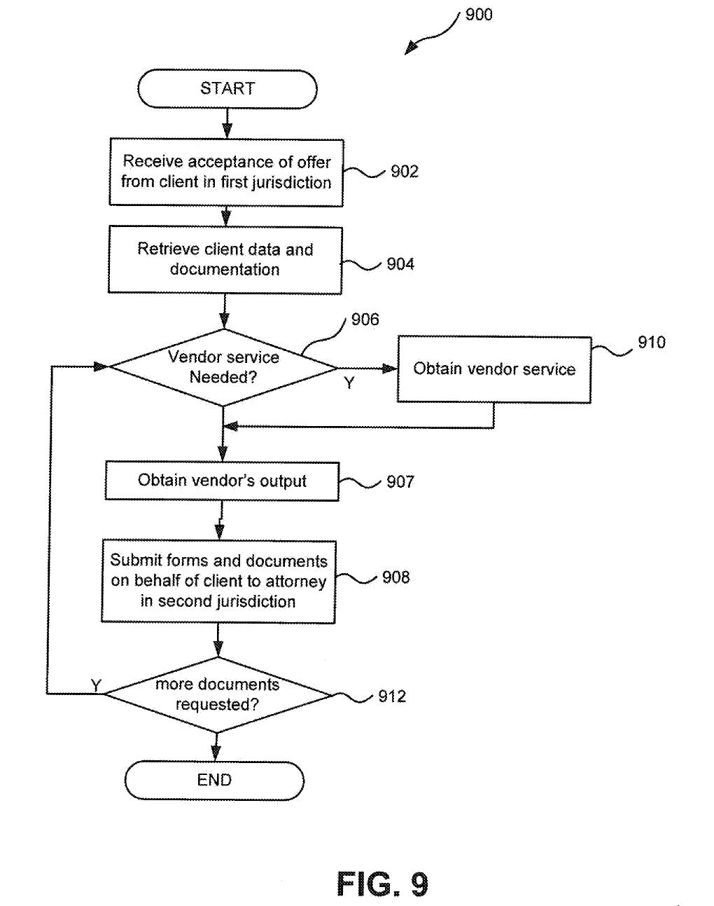

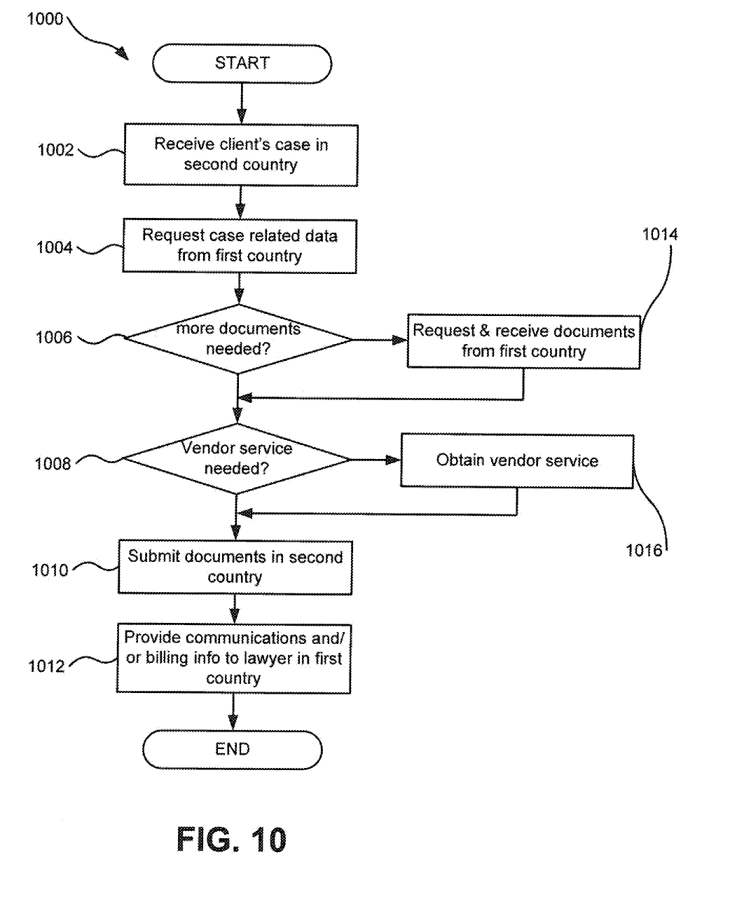

In another embodiment, the family may wish to initiate the case against the company from Kenya upon their return. Further, the family has the option of contacting a local Kenyan attorney that is a member of the system 10 to help them select and communicate with a competent attorney in New Zealand. The scenario in this embodiment is depicted in FIG. 8, FIG. 9 and FIG. 10 and described below.

Thus, as shown in flowchart 800 of FIG. 8, upon return to the first country (Kenya) the client—in this case a member of the family—logs into the portal of system 10 (step 802); provides a description of the case (step 804); sends a request for professional legal service (step 804) and finally receives and accepts an offer from a qualified professional attorney in Kenya (step 806).

The actions of the attorney the first jurisdiction (in Kenya) are depicted in flowchart 900 of FIG. 9. As shown, upon receiving acceptance of the offer (step 902) the attorney in Kenya retrieves the client's data and documentations for the case, already provided by the family (step 904). Since the data and documentation may be provided in a language (e.g., Swahili which is widely used in Kenya), instead of the language used in the jurisdiction where the legal case would be brought into a court of law (e.g., English—for New Zealand) the first attorney may engage the services of a translator to translate documents from Swahili to English.

Recall that a translator is a type of vendor defined in the data model of system 10 depicted in FIG. 2. Accordingly, if the service of a vendor (e.g., a translator) is needed (step 906) then the vendor's service is engaged (step 910) by sending documents to be translated along with a vendor service request to the vendor, and the obtaining the vendor's output or work product, in the form of translated forms and documents, are obtained (step 907) and subsequently submitted to a second attorney (i.e., the attorney in New Zealand) on behalf of the first client by the first attorney (step 908). If additional documents are required (Step 912) then they are similarly provided to the second attorney in New Zealand with translations done as required.

The actions undertaken by the second attorney in New Zealand for the exemplary embodiment described above are detailed below. FIG. 10 depicts a flowchart 1000 summarizing the actions of the second attorney in New Zealand. Accordingly, the second attorney in New Zealand initially receives the client's case (step 1002). The attorney may then request information (step 1004) pertinent to the case for the first country or jurisdiction. If additional documentation is required (step (step 1006) then the second attorney requests and receives the documents (step 1014). If the documents have been translated to the local working language (e.g. English for New Zealand) then the attorney submits the documents in the second country to the relevant institution (step 1010) such as a court of law. However, if the documents have not been translated and translation is required, then the second attorney may engage the services of local vendor (in this example, a translator), using system 10 (step 1016). After the documents or briefs are filed with the appropriate institution or relevant court of law, the second attorney may communicate the status and/or provide billing related information to the first attorney in the first country or jurisdiction (step 1012) which concludes the flowchart 1000.

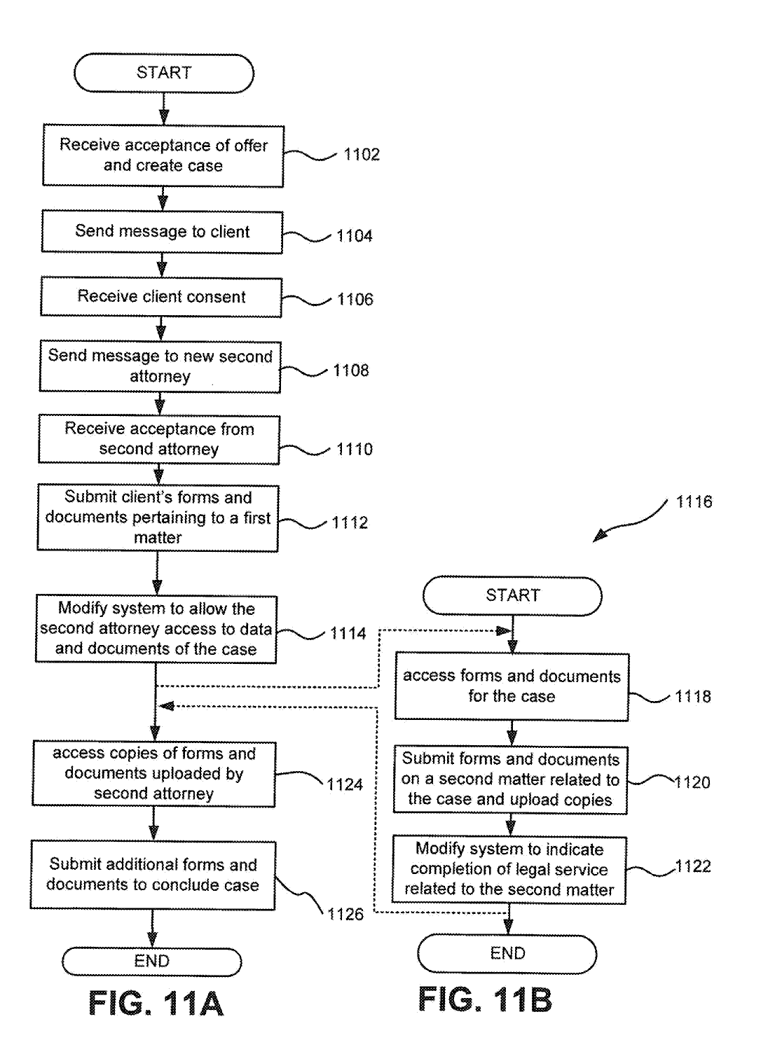

FIG. 11A and FIG. 11B depict flowcharts depicting the actions undertaken by a first and second attorneys cooperating on a single case, by working on separate matters related to the case. For simplicity of illustration, consider a case having just two legal matters at issue. The case is primarily handled by the first attorney. The first attorney handles the first matter but requires assistance from a second attorney on a second matter. This may arise in the example discussed below where different jurisdictions are involved and each attorney is licensed to practice in his respective jurisdiction only. It may also involve specialized advice sought regarding for example, a secondary immigration related matter, on a case that primarily involves child adoption from a foreign country. Many cases involve many matters requiring different types of legal expertise, and such cases often require the cooperation of many lawyers to be handled to a successful completion.

FIG. 11A depicts a flowchart 1100 summarizing the actions of the first professional or primary attorney in a case involving a primary or first matter, and a secondary matter. Accordingly, the first attorney initially accepts the client's offer and creates a case (step 1102) in the server computers of system 10. The first attorney may then request permission from the client to involve another second professional by sending a message (step 1104). Upon receiving the client's consent (step 1106) the attorney sends a message to a second professional or attorney (step 1108) asking for his or her service, to work on the second matter in the case. Upon receiving the acceptance message from the second attorney (step 1110) the first attorney proceeds to handle the first matter by, for example, filling out the necessary forms and submitting the forms and related documents (step 1112) to the respective court, agency or office. Upon receiving the acceptance message from the second attorney, the first attorney modifies the system to allow the second attorney access to data and documents of the case that may be needed to handle the second matter related to the case. This may be accomplished by adding the second attorney as a secondary attorney to the case. Alternately, if only one attorney is to be associated as a sole representative with a case according to the data model of system 10, or due to the nature of the case, then the case is simply be transferred to the second attorney as described earlier.

At this point the second attorney provides legal service on the second matter in accordance with flowchart 1116 of FIG. 11B. After being granted access in step 1114, the second attorney accesses documents related to the case (step 1118), and may further upload forms and documents related to the second matter (step 1120) and modifies system 10 to indicate completion of the legal service related to the second matter (step 1122). In some embodiments, step 1122 may involve transferring the case back to the primary attorney as discussed earlier. In other embodiments, it may simply be a status change on a predetermined indicator field accessible to the first attorney's account or the client's account. Many ways of passing such indications of completion of work will be known to persons of skill in the art. Alternately, emails, text messages, chat messages, tweets and the like can also be used to send messages.

Referring again to FIG. 11A, at step 1124, the first attorney access forms, data and documents uploaded by the second attorney as part of the legal service provided to handle the second matter related to the case. The first or primary attorney may then further handle to case by submitting additional forms or documents and bring the case to completion (step 1126).

In alternate embodiments, the system 10 may prevent conflicts of interest by preventing registered attorneys from offering to represent a client if they are already representing the opposing party in a case, provided that the case is created and handled by the system 10.

Although many of the specific exemplary embodiments have been described herein with reference to a legal service and attorneys, those of skill in the art will appreciate that the invention applies to any professional service provided by professionals to a client. Accordingly other professional services other than the legal profession such as accounting services, patent agency services, trademark agency services, and the like may be accommodated by the present invention.

Although embodiments have been described above with reference to the accompanying drawings, those of skill in the art will appreciate that variations and modifications may be made without departing from the spirit and scope thereof as defined by the appended claims.

What is claimed is:

1. A method of providing a service to a client on a case, using a computer system having data related to the case stored in memory, the system having an account for each of a first professional and a second professional, the data accessible to the first professional's account but inaccessible the second professional's account; said method comprising:
logging in to the first professional's account;
sending a request message to the second professional's account requesting the second professional to work on the case;
receiving an acceptance message from the second professional's account indicating acceptance; and
upon receiving the acceptance message, making the data accessible to the second professional's account thereby allowing the second professional to work on the case.

2. The method of claim 1, further comprising storing the data in the memory prior to said sending said request message.

3. The method of claim 1, further comprising creating each said account for the first professional and the second professional prior to said logging in.

4. The method of claim 3, further comprising: prior to said creating each said account:
receiving information related to professional credentials for the first professional and the second professional; and
proceeding with said creating only after ascertaining that the information is accurate.

5. The method of claim 1, wherein the system further has an account for the client, the method further comprising: prior to said sending said request message,
sending a consent request message to the client's account requesting consent from the client to have the second professional work on the case; and
receiving a consent message indicating said consent from the client.

6. The method of claim 1, wherein the service is a legal service, the first professional is a first attorney working on the case, and the second professional is a second attorney assisting the first attorney on the case.

7. The method of claim 6, wherein the case comprises a first matter and a second matter and the first attorney and the second attorney collaborate by working on the first matter and the second matter respectively.

8. The method of claim 6, wherein the first attorney is licensed to practice law in a first jurisdiction and the second attorney is licensed to practice law in a second jurisdiction different from the first jurisdiction.

9. The method of claim 7, wherein the first jurisdiction is in a first geographic region and the second jurisdiction is in a second geographic region different from the first region.

10. The method of claim 8, wherein the first region is a first country and the second region is a second country different from the first country.

11. The method of claim 6, wherein the first attorney is initially a sole representative of the client for the case, the method further comprising:
transferring the case from the first attorney to the second attorney, after said making the data accessible, thereby making the second attorney the sole representative.

12. The method of claim 1, wherein the system further has an account for a vendor, the method further comprising: prior to said sending said request message,
sending a vendor service request message to the vendor's account;
receiving the vendor's output.

13. The method of claim 12, wherein said vendor is one of: a bond service provider, a translator, and a financial service provider.

14. A server comprising: a processor; a network interface for interconnecting to a computing device through a network, the network interface; and memory coupled to the processor, the memory storing processor executable instructions adapting the processor to:
maintain an account for each of a client, a first professional and a second professional;
receive user input from the device provided by a user logged into one of the client's account and the first professional's account and in response to said user input:
store data related to a case associated with the client in said memory such that the data accessible to the first professional's account but not the second professional's account;
send a request message to the second professional's account requesting the second professional to work on the case;
receive an acceptance message from the second professional indicating acceptance; and
upon receipt of the acceptance message, make the data accessible to the second professional's account thereby allowing the second professional to work on the case.

15. The server of claim 14, wherein the processor executable instructions comprise at least one of: a web-server software and a database software storing the data.

16. The server of claim 15, wherein the server comprises a plurality of interconnected server computers accessible to the computing device through said network.

17. The server of claim 14, wherein the processor executable instructions further adapt the processor, prior to said sending said request message, to enable the user, when logged into the first professional's account to:
send a consent request message to the client's account requesting consent from the client to have the second professional work on the case; and
receive a consent message from the client's account indicating the consent.

18. A computing device for providing a service to a client on a case, comprising:
a processor; an input device; memory storing processor executable instructions; and a network interface for interconnection to a server having an account for each of the client, a first professional and a second professional, the server storing data related to the case, the input device, network interface and memory connected to the processor, the instructions adapting the processor to:
receive login input through the input device to log into the first professional's account on the server;
send a request message to the second professional's account requesting the second professional to work on the case;
upon receipt of an acceptance message from the second professional's account indicating acceptance, transmit commands to the server making the data accessible to the second professional's account thereby allowing the second professional to work on the case.

19. The computing device of claim 18, wherein the processor executable instructions comprise a browser.

20. The computing device of claim 18, wherein the device is one of a laptop computer, a desktop computer, a tablet computer and a smart-phone.
